(19) United States
(12) Patent Application Publication
(10) Pub. No.: US 2026/0245071 A1
(43) Pub. Date: Aug. 20, 2026

(54) ATTRIBUTE AND DEPENDENCY SUPPORT IN A DIGITAL WALLET

(71) Applicant: International Business Machines Corporation, Armonk, NY (US)

(72) Inventor: Milan Saumil Patel, Raleigh, NC (US)

(73) Assignee: International Business Machines Corporation, Armonk, NY (US)

(21) Appl. No.: 19/053,525

(22) Filed: Feb. 14, 2025

(51) Int. Cl. G06Q 20/36; G06Q 20/40

(52) U.S. Cl. CPC G06Q 20/3674; G06Q 20/401

(57) ABSTRACT

An embodiment includes responsive to receiving from an issuer a credential by a digital wallet of a holder on a holder device, determining a dependency between the credential and a verifier. The embodiment includes provisioning a dataset based on the credential. The embodiment includes deciding to send the dataset to the verifier wherein at least one attribute of the credential is sent to the verifier. The embodiment also includes determining a dependency between the credential and the verifier wherein the verifier subscribes to the credential.

### BACKGROUND

The present invention relates generally to computer storage. More particularly, the present invention relates to a method, system, and computer program for Attribute and Dependency Support in a Digital Wallet.

Mobile devices have become synonymous with modern life. Mobile devices are used in eCommerce, medical settings, banking, government services, and secure transactions. It is estimated that by 2026 over 5.3 billion people, more than half the world's population, will own and use digital wallets. These devices have wireless capabilities like Bluetooth, WiFi, and magnetic signals to transmit payment data securely from the device to a remote device such as a point of sale designed to read the data and connect via these signals.

Currently, the technologies contained in mobile devices that are used for different tasks include quick response (QR) codes which are matrix bar codes that store information, the device's camera and scanning system to initiate payment. Near field communication (NFC) is a technology that allows two smart devices to connect and transfer information using electromagnetic signals. It requires two devices to be close to each other to connect. Digital wallets make use of some of these technologies to pay for purchases and to allow the holder to conduct other transactions. Digital wallets can also support gift cards, membership cards, loyalty cards, coupons, event tickets, plane and transit tickets, hotel reservations, driver licenses, identification cards, and car keys.

### SUMMARY

The illustrative embodiments provide for Attribute and Dependency Support in a Digital Wallet. An embodiment includes responsive to receiving from an issuer a credential by a digital wallet of a holder on a holder device, determining a dependency between the credential and a verifier. The embodiment includes provisioning a dataset based on the credential. The embodiment also includes deciding to send the dataset to the verifier wherein at least one attribute of the credential is sent to the verifier.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

An embodiment includes responsive to receiving from a first issuer a first credential by a holder device, determining a first dependency between the first credential and a verifier. The embodiment includes determining a second dependency between a second credential and the verifier wherein the second credential is received from a second issuer based on the first credential. The embodiment also includes provisioning a dataset based on the first credential and the second credential. The embodiment also includes deciding to send the dataset to the verifier wherein at least one attribute of the first credential and at least one attribute of the second credential are sent to the verifier.

An embodiment includes a data store storing a credential received from an issuer. The embodiment includes a subscription component wherein a verifier subscribes to the credential. The embodiment includes a dependency component wherein the dependency component determines a dependency between at least one attribute of the credential. The embodiment also includes graphical user interface wherein the graphical user interface displays the dependency.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a diagram of a digital wallet in an environment in accordance with an illustrative embodiment;

FIG. 3 depicts a block diagram of a digital wallet system in an environment in accordance with an illustrative embodiment;

FIG. 4 depicts a block diagram of a digital wallet system receiving an upstream update from an issuer in an environment in accordance with an illustrative embodiment;

FIG. 5 depicts a diagram of an example graphical user interface (GUI) of a digital wallet in an environment in accordance with an illustrative embodiment;

FIG. 6 depicts a flow chart of an example process for determining attribute and dependency of a digital wallet in an environment in accordance with an illustrative embodiment; and

FIG. 7 depicts a system diagram that illustrates an example digital wallet system in accordance with an illustrative embodiment.

### DETAILED DESCRIPTION

With the advent of newer technologies such as decentralized identity, individual, as well as end users, will have more control over their identity, including their relationships with other identifiers, entities and attributes. These dependencies and attributes will reside in a “digital” wallet owned by the individual, allowing for the explicit ownership and management, similar to how holders store and manage physical renderings of credentials in physical wallets and purses today.

Verifiable Credentials (VCs) are digital proofs that validate specific facts about individuals, organizations, or entities. Another way to think of VCs is that they are digital versions of traditional documents. Given the complex nature of types of digital credentials an individual can manage, there exist upstream and downstream sets of dependencies through the credential lifecycle chain. Holders may use credentials to obtain more credentials, creating an implicit dependency chain between the credential and a relationship that may have verified the credential before issuing their own credential and/or updating their system of record.

Currently, there is no way for the holder to view the inter-dependencies between credentials. If upstream credential attributes are modified, downstream credential attributes dependent on those upstream credential attributes need to be easily identifiable such that a holder managing their own sets of attributes can understand the dependencies. There is also no way for the holder to define which relationships to not share attribute updates with and which relationships to share attribute updates with based on the relationship mapping. In the case where the holder has pre-selected to automatically update relationships of attribute updates, another shortcoming is that when an attribute of a credential changes, there is no way for the holder to notify or trigger any dependent credential issuers that specific attributes were updated. There also does not exist a granular mechanism to allow the holder to select which issuers to automatically notify when any attribute changes.

The following description provides examples of embodiments of the present disclosure, and variations and substitutions may be made in other embodiments. Several examples will now be provided to further clarify various aspects of the present disclosure.

Example 1: A computer-implemented method that comprises responsive to receiving from an issuer a credential by a digital wallet of a holder on a holder device, determining a dependency between the credential and a verifier. The method further comprises provisioning a dataset based on the credential. The method further comprises deciding to send the dataset to the verifier wherein at least one attribute of the credential is sent to the verifier.

The above limitations advantageously enable automated linkage between a credential and an issuer within the corpus of a holder device to enable transparency of the dependencies of the credential to a downstream verifier to use the issued credential as part of a proof request/response flow. The limitations enable which attributes of a credential are not able to automatically get an update. The above limitations advantageously enable improvements to the computer resources since dependencies between a credential and a verifier are efficiently handled.

The term “credential” as used herein, and without implying any limitation thereto, may refer to a digital proof that validate specific facts about individuals, organizations, or entities. A credential may comprise of attributes and other meta data as part of the holder obtaining, storing, and presenting credentials. The term may also refer to a set of identifiers, such as a password and username, that allows a device to connect to a network.

The term “digital wallet” as used herein, and without implying any limitation thereto, may refer to a data store in a holder device that stores a holder's credentials, including but not limited to an attribute of the credential and/or dependency between the attribute and a verifier, a dependency between an issuer and the holder, a dependency between issuers, and/or a dependency between an issuer and a verifier.

The term “holder” as used herein, and without implying any limitation thereto, may refer to a person, an entity or any representation of the aforementioned possessing one or more verifiable credentials in a holder/s digital wallet and generating verifiable presentations from the credentials.

The term “verifier” as used herein, and without implying any limitation thereto, may refer to a role an entity or a person performs by receiving one or more verifiable credentials, optionally inside a verifiable presentation for processing. Other specifications might refer to this concept as a relying party. The term “verifiable” as used herein, and without implying any limitation thereto, may refer to an evaluation of whether a credential is an authentic and timely statement of the issuer.

The term “dependency” as used herein, and without implying any limitation thereto, may refer to a constraint and/or a rule that defines a relationship between a credential and a verifier.

The term “provisioning” as used herein, and without implying any limitation thereto, may refer to a process performed by a computer processor and computer memory of making data available to a holder and/or third-party users of the digital wallet system in a structured and secure way.

Example 2: The limitations of Example 1, wherein the holder device displays via a graphical user interface of the holder device a selection whether to send the credential to the verifier and wherein the selection causes the provisioning of the dataset to omit an attribute of the credential.

The above limitations advantageously enable a holder of the holder device to select whether to send a credential to a verifier thereby improving computer data security of private or confidential information. Additionally, the limitations realize the benefits described with respect to Example 1.

Example 3: The limitations of Example 1, comprising determining a dependency between the credential and the verifier wherein the verifier subscribes to the credential.

The above limitations advantageously enable a dependency to be determined between a credential and a verifier that subscribes to the credential. Additionally, the limitations realize the benefits described with respect to Examples 1-2.

The term “subscribes” as used herein, and without implying any limitation thereto, may refer to a verifier that registers its interest of a credential with a holder device.

Example 4: The limitations of Example 1, where the dataset comprises an attribute of the credential from the issuer that is persistent in a data store of the holder device.

The above limitations advantageously enable an attribute to be accessed and used by other issuers, verifiers and data stores even after the issuer that created the attribute has closed its connection. Additionally, the limitations realize the benefits described with respect to Examples 1-3.

The term “persistent” as used herein, and without implying any limitation thereto, may refer to a process of storing an attribute in a way that allows it to be accessed and used by other issuers, verifiers and data stores even after the issuer that created it has closed its connection.

Example 5: The limitations of Example 1, where the deciding is based on a change in the credential received from the issuer.

The above limitations advantageously enable the decision to send a dataset to be based on a change in a credential from the issuer which may prevent unnecessary data to be sent thereby saving computer resources. Additionally, the limitations realize the benefits described with respect to Examples 1-4.

Example 6: The limitations of Example 1, where the deciding is based on a request from the verifier where the holder determines whether to accept the request.

The above limitations advantageously enable the decision to send a dataset to be based on a request from a verifier improving the functionality of a computer to support a verifier request to go through the holder device to the issuer. The limitations realize the benefits of improved computer data security of personal and confidential data. Additionally, the limitations realize the benefits described with respect to Examples 1-5.

Example 7: The limitations of Example 1, further comprising sending a notification to the verifier of a change to the credential received from the issuer.

The above limitations advantageously enable a verifier to be informed of a change to a credential received from an issuer. Additionally, the limitations realize the benefits described with respect to Examples 1-6.

The term “notification” as used herein, and without implying any limitation thereto, may refer to an alert that informs a holder device of new messages or updates.

Example 8: A computer program product comprising one or more computer readable storage media, and program instructions collectively stored on the one or more computer readable storage media, the program instructions executable by a processor to cause the processor to perform the method according to any of Examples 1-7. The computer program product of Example 6 realizes the benefits described with respect to Examples 1-7. The computer program product of Example 6 can advantageously be implemented into a variety of computer program products.

Example 9: A computer system comprising a processor and one or more computer readable storage media, and program instructions collectively stored on the one or more computer readable storage media, the program instructions executable by the processor to cause the processor to perform the method according to any of Examples 1-7. The computer system of Example 9 realizes the benefits described with respect to Examples 1-7. The computer system of Example 9 can advantageously be implemented into a variety of computer devices.

Example 10: A computer-implemented method that comprises responsive to receiving from an issuer a credential by a holder device; determining a dependency between the credential and a verifier. The method further comprises provisioning a dataset based on the credential. The method further comprises deciding to send the dataset to the verifier wherein at least one attribute of the credential is sent to the verifier. The method further comprises determining a dependency between the credential and the verifier wherein the verifier subscribes to the credential. The method further comprises an attribute of the credential from the issuer that is persistent in a data store of the holder device. The above limitations realize the technical benefits described with respect to Examples 1-7.

Example 11: A computer-implemented method that comprises responsive to receiving from a first issuer a first credential by a holder device, determining a first dependency between the first credential and a verifier. The method further comprises determining a second dependency between a second credential and the verifier wherein the second credential is received from a second issuer based on the first credential. The method further comprises provisioning a dataset based on the first credential and the second credential. The method further comprises deciding to send the dataset to the verifier wherein at least one attribute of the first credential and at least one attribute of the second credential are sent to the verifier. The above limitations realize the technical benefits described with respect to Examples 1-7.

Example 12: A system that comprises a datastore storing a credential received from an issuer. The system further comprises a subscription component wherein a verifier subscribes to the credential. The system further comprises a dependency component wherein the dependency component determines a dependency between at least one attribute of the credential. The system further comprises a graphical user interface wherein the graphical user interface displays the dependency. The system further comprises further comprising a notification component wherein the notification component displays a notification responsive to receiving the credential from an issuer. The above limitations realize the technical benefits described with respect to Examples 1-7.

Aspects of the present disclosure can be implemented in a variety of technical use cases. The following use cases are merely exemplary and are not intended to limit the scope of the disclosure.

In a use case, a holder device receives a driver license credential issued by a government entity such as a department of motor vehicles (DMV). A verifier, an auto insurance company subscribes to the attributes of the credential, in other words, a dependency exists between the attributes and the auto insurance company. The GUI of the holder device displays the dependencies. The holder selects to approve the sending of the driver license number to the auto insurance company but not the social security number. A dataset payload is provisioned to include the driver license number, and the payload is sent to the auto insurance company over a secure channel.

In another use case, a holder device receives an employment record credential issued by a holder's employer on the holder's device. A bank application requests the employment record credential but also requests a driver license credential issued by the DMV. The holder device requests the driver license credential from the DMV using the holder's name and address obtained from the holder's employer as input. A dataset payload is provisioned to include the salary attribute from the employment record credential and the driver license number attribute from driver license credential, and the payload is sent to the auto insurance company over a secure channel.

The present disclosure provides for a method, a machine-readable medium, and a system for Attribute and Dependency Support in a Digital Wallet.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

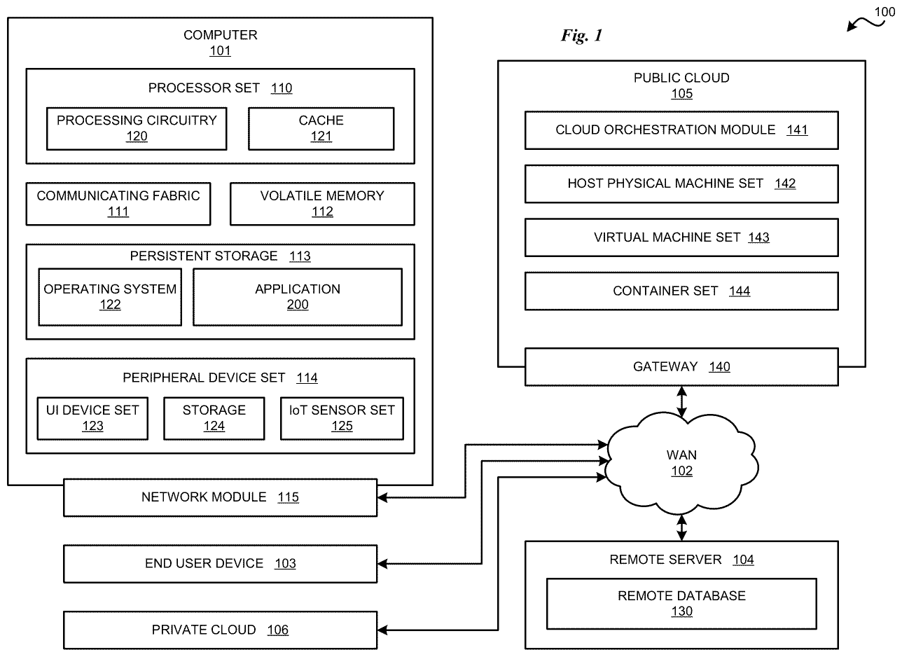

With reference to FIG. 1, this figure depicts a block diagram of a computing environment 100. Data center environment 100 contains an example of an environment for the execution of at least some of the computer code involved in performing the inventive methods, such as an Application 200 that provides Attribute and Dependency Support in a Digital Wallet. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made. Available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of Application Programming Interfaces (API). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

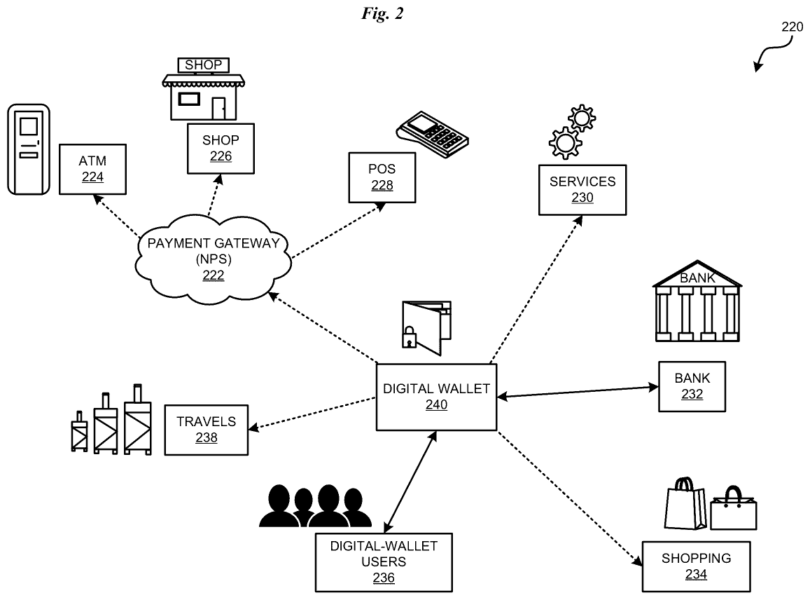

FIG. 2 depicts a diagram of a digital wallet in an environment in accordance with an illustrative embodiment. In a particular embodiment, the components of the diagram 220 show aspects of the Application 200 of FIG. 1.

In the illustrated embodiment, a digital wallet 240 communicates with a peer which is a remote entity that may be an end-user, vendor, or bank wallet that is capable of performing operations on instruments and/or data according to a protocol. For example, a peer may be a payment gateway 222, that supports an Automated Teller Machine (ATM) 224, a shop 226, and a point of sale (POS) 228. A digital wallet 240 may also communicate with services 230, a bank 232, shopping 234, other digital wallet users 236, and travel platform 238. In some embodiments, the digital wallet 240 may comprise a Near-field communication (NFC), Bluetooth, and/or TCP/IP protocols.

In embodiments, a digital wallet may contain a holder's verifiable credentials (VCs) which are digital proofs that validate specific facts about individuals, organizations, or entities. For example, VCs may be digital representations of traditional identification documents. They often look like digital badges stored securely in your smartphone's wallet app. A digital wallet may store things such as state ID or passport on the holder's device as VCs.

In embodiments, the holder of a digital wallet controls, such as by holder selection or automatically, which credentials, credential attributes and/or dependencies are stored in the digital wallet and/or sent and/or presented from the digital wallet.

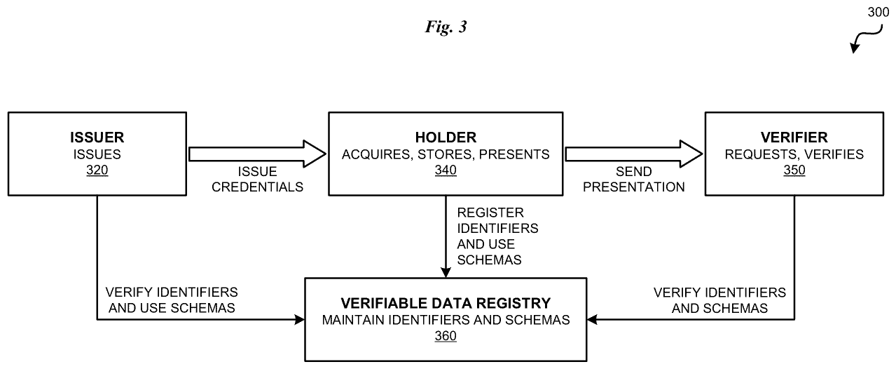

FIG. 3 depicts a block diagram of a digital wallet system in an environment in accordance with an illustrative embodiment. In a particular embodiment, the components of the diagram 300 show aspects of the Application 200 of FIG. 1.

In the illustrated embodiment, a holder 340 receives a credential issued by an issuer 320 and sends to a verifier 350. The holder 340 acquires, holds and presents the credential in a verifiable data registry 360 such as a data store. The verifiable data registry 360 maintains verification identifiers and schemas received from the issuer as well as identifiers and schemas from the verifier.

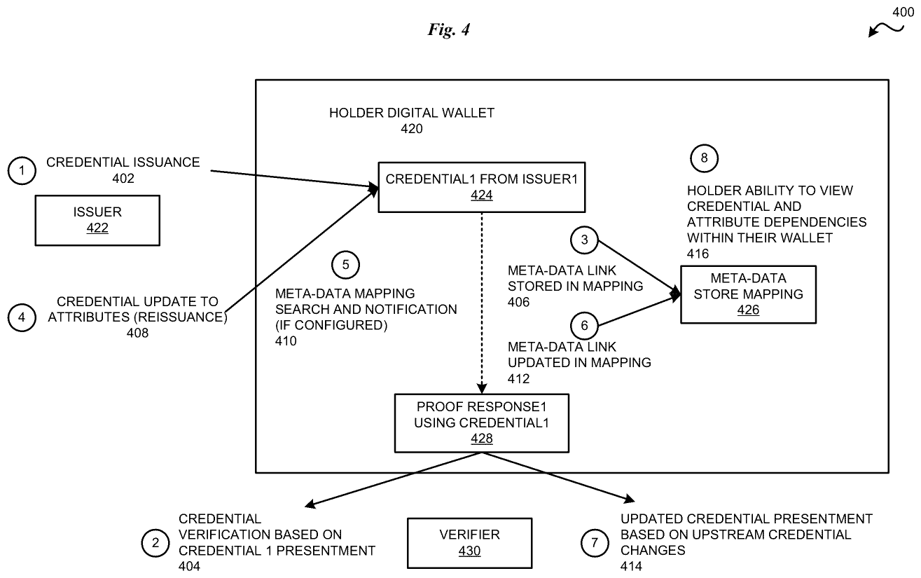

FIG. 4 depicts a block diagram of a digital wallet system receiving an upstream update from an issuer in an environment in accordance with an illustrative embodiment. In a particular embodiment, the components of the diagram 400 show aspects of the Application 200 of FIG. 1.

In the illustrated embodiment, a holder's digital wallet 420 receives a credential 424 issuance 402 from an issuer 422. For example, an issuer may comprise a third party or entity for example, a city government, national agency, or certification body. A credential may comprise of information related to identifying the subject of the credential (for example, a photo, name, or identification number), information related to the issuing authority, information related to the type of credential this is (for example, a Dutch passport, an American driving license, or a health insurance card), information related to specific attributes or properties being asserted by the issuing authority about the subject (for example, nationality, the classes of vehicle entitled to drive, or date of birth), evidence related to how the credential was derived, and information related to constraints on the credential (for example, expiration date, or terms of use). Holders of verifiable credentials can generate verifiable presentations and then share these verifiable presentations with a verifier 430 to prove they possess verifiable credentials with certain characteristics.

In some embodiments, the holder device may display a selection to a holder whether to approve the reception of a credential from an issuer. A holder may approve and/or deny any attribute of the credential or deny the entire credential. A selection may cause a sending of a confirmation to the issuer and/or reason why the reception was denied.

In an embodiment, a credential received from an issuer may comprise a Connection ID, Credential ID, a Credential definition ID, an Issuer ID, and an attribute. A payload received by a holder device may show:

```
″connection_did″: ″CCCCCCCIDCCCCCCCCCCCCC″,
  ″cred_id″: ″6f4151cd-042d-428f-953b-b0beeacc6c8f″,
  ″credential_definition_id″:
  “V16FcuVb5wVajvYgyQHjjn:3:CL:79:TAG1”,
  ″id″: ″121600166287″,
  ″issuer_did″: ″ DDDDDDDDDDDDDDDDDDDD12″,
  ″offer″: {
    ″attributes″: {
      ″Base Salary″: ″90000″,
      ″Company″: ″Company″,
      ″Date of Birth″: ″04-15-1982″,
      ″First Name″: ″Name″,
      ″Hire Date″: ″2/29/2016″,
      ″Job Title″: ″Software Developer″,
      ″Last Name″: ″LName″,
      ″Social Security Number″: ″o0FAwXSz6V″,
      ″card_back″: ″″,
```

In embodiments, the credential is presented to the verifier 430 satisfy verification 404 using the credential as a proof response 428. For example, a payload of a dataset sent to the verifier from a holder device may comprise a proof response ID, an issuer Credential definition ID, a revealed attribute, and a Verifier DID as shown below:

```
“verifier_did”: “ DDDDDDDDDDDDDDDDDDDD13”,
{
      “cred_def_id”: “V16FcuVb5wVajvYgyQHjjn:3:CL:79:TAG1”,
      “name”: “basesalary”,
      “value”: “90000”
    }
}
“proof_request”: {
  “id”: “Verify Employment:1.01579183903859”,
“requested_proof”: {
    “predicates”: { },
    “revealed_attrs”: {
      “Base Salary”: {
        “encoded”: “90000”,
        “raw”: “90000”,
        “sub_proof_index”: 1
      }
}
```

The dataset comprising attributes such as “verifier_did” and “cred_def_id” that determine the dependency between a credential attribute and a verifier may be stored in the data store 426 for future access 406. In some embodiments, the attributes may be stored in persistent storage that allows it to be accessed and used by other issuers, verifiers and data stores even after the issuer that created it has closed its connection. The data store 426, in addition to storing the various dependencies and mappings, also enable the holder to view credential and attribute dependencies within the digital wallet 416.

In an embodiment, a credential is updated by an issuer 408, such as a reissuance of a credential. A reissuance may include an update to any credential attribute. The system determines using the data store and/or credential attributes, a dependency between the credential and a verifier 410 and updates the data store with the dependency 412. For example, the data store may comprise of the attributes “meta_data_mapping_id”, “issuer_credential_definition_id”, “verifier_did” as shown below:

```
{
    ″mapping″: {
    ″meta_data_mapping_id″: “9184749fbhebfibhfgj″,
  “Verifiers”: {
      ″proof_response_id″: ″013579906886″,
        “issuer_credential_definition_id”:
      “V16FcuVb5wVajvYgyQHjjn:3:CL:79:TAG1”,
        ″attributes_verrified” {
              ″Base Salary″: ″90000″,
              ″Company″: ″Company″,
              ″First Name″: ″Name″,
              ″Last Name″: ″LName″,
              ″Social Security Number″: ″o0FAwXSz6V″,
                }
        ″verifier_did″: ″ DDDDDDDDDDDDDDDDDDDD13″,
          }
    “Issuers”: {
          ″id″: ″aaaaaaaa-bbbb-cccc-dddd-eeeeeeeeeeee″,
        ″issuer_did″: ″ DDDDDDDDDDDDDDDDDDDD12″,
        “issuer_credential_id”:
        “6f4151cd-042d-428f-953b-b0beeacc6c8f”,
        “issuer_credential_definition_id”:
“V16FcuVb5wVajvYgyQHjjn:3:CL:79:TAG1”
        “Attributes”
            {
              ″Base Salary″: ″90000″,
              ″Company″: ″Company″,
              ″First Name″: ″Name″,
              ″Last Name″: ″LName″,
              ″Social Security Number″: ″o0FAwXSz6V″,
            }
                  }
          }
  }
```

The updated credential is sent to the verifier based on an upstream credential change 414.

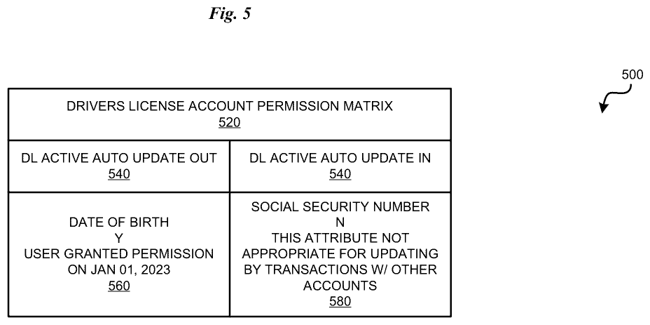

FIG. 5 depicts a diagram of an example graphical user interface (GUI) of a digital wallet in an environment in accordance with an illustrative embodiment. In a particular embodiment, the components of the diagram 500 show aspects of the Application 200 of FIG. 1.

In the illustrated embodiment, a GUI of a driver license (DL) account permission matrix 520 may comprise a selection for DL Active Auto Update Out 540 (a selection to opt out of automatic update of a DL attribute) and DL Active Auto Update In 540 (a selection to opt in automatic update of a DL attribute). In this example, the holder has also granted permission for the date of birth attribute of the DL credential to be sent and/or presented to a verifier 560. The social security number attribute of the credential, however, is not approved 580. This example only illustrates a simple snapshot of a GUI. In other aspects, the GUI may display and may enable an interface to features as described herein.

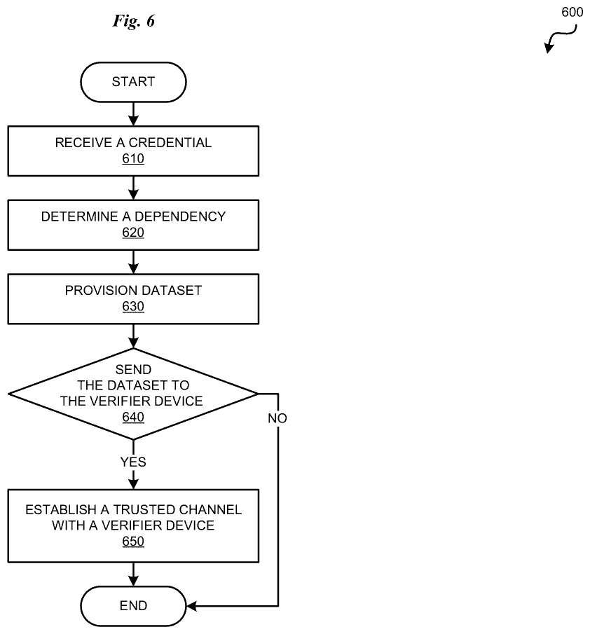

FIG. 6 depicts a flow chart of an example process for determining attribute and dependency of a digital wallet in an environment in accordance with an illustrative embodiment. In a particular embodiment, the components of the diagram 600 show aspects of the Application 200 of FIG. 1.

In the illustrated embodiment, at step 610 a credential is received from an issuer by a holder device through a network. The system determines a dependency between the credential and a verifier at step 620. For example, a dependency between the credential and a verifier is determined if the verifier subscribes to the credential. In an aspect, a verifier subscribes to a credential of an issuer if the verifier is added to the digital wallet of the holder device with a selection that causes an attribute such as “verifier did” to be associated with an attribute such as “issuer_credential_definition_id” in the data store as described above. In another aspect, a verifier such as an automobile insurance company subscribes to the driver license credential issued by a government entity. The data store may be queried for these dependencies using known methods such as Structured Query Language (SQL) for a relational database or an object database query uses Object Query Language (OQL) to retrieve data from an object database.

In another embodiment, a dependency between the credential and a verifier is determined from a request of a verifier received by the digital wallet. In an aspect, a digital wallet receives a request from a verifier such as an automobile insurance company when an insurance policy changes, and the company requires proof of a driver license credential. The holder, in some examples, may be displayed a selection whether to accept or deny the request. Accepting the request may cause a dataset to be provisioned with a response and an dependency attribute stored in the data store.

In another embodiment, a dependency may be determined between the first credential issued by a first issuer, a second credential issued by a second issuer and a verifier. For example, the first credential may be a driver license issued by a government entity and the second credential may be an employment credential issued by a holder's employer. The verifier, such as an automobile insurance company may be dependent on a first attribute of the driver license, for example, a driver license number, and a second attribute of the employment credential, for example, salary of the holder. This may cause an attribute such as “verifier did” to be associated with an attribute such as “issuer1_credential_definition_id” and an attribute such as “issuer2_credential_definition_id” in the data store.

At step 630, a dataset may be provisioned comprising an attribute of an issuer as described above. For example, data provisioning is the process of making the dataset available to a verifier in a structured and secure way. It involves extracting, transforming, and loading data from one system to another. The steps in data provisioning may comprise identifying the data source such as an issuer, extracting the data from the source system, and transforming the data for use by the target system. In some examples, the digital wallet on the holder device extracts attributes of a credential received from the issuer using known methods such as Optical Character Recognition (OCR) which is the electronic or mechanical conversion of images of typed, handwritten or printed text into machine-encoded text.

At step 640, a decision is made whether to send the previsioned dataset to the verifier. In some examples, this step may be performed before, in parallel or after step 630. For example, the decision may be based on whether a dependency exists between an attribute of a credential and a verifier. In another example, the holder may have selected to omit an attribute from the dataset. For instance, the holder may deny the sending of sensitive Personally Identifiable Information (PII) data such as the holder's social security number.

If the decision is YES, the provisioned dataset is sent to a verifier. In one aspect, the dataset is sent to the verifier over a secure channel 650 and/or in accordance with a known industry standard. The process then ends.

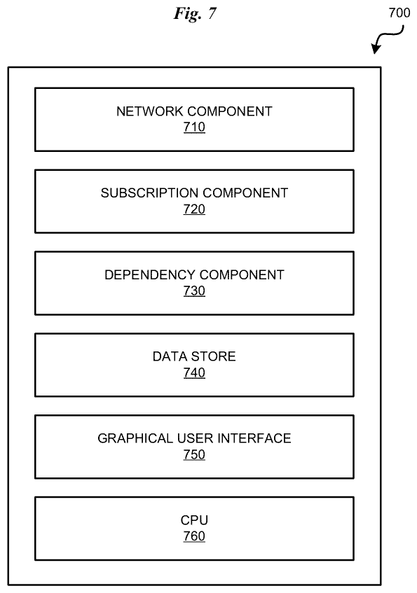

FIG. 7 depicts a system diagram that illustrates an example digital wallet system in accordance with an illustrative embodiment. In a particular embodiment, the components of the diagram 700 show aspects of the components of FIGS. 1-6.

In the illustrated embodiment, digital wallet system may comprise a network component 710, a subscription component 720, a dependency component 730, a data store 740, a graphical user interface (GUI) 750 and a central processing unit (CPU) 760. For example, the network component may comprise a network adaptor, a socket, a graphics card, one or more routers, switches, hubs, and/or other network connectivity devices. The network component may transmit and/or receive data via network links such as data may be transmitted and/or received using Wireless Application Protocol (WAP), Multimedia Messaging Service (MMS), Enhanced Messaging Service (EMS), Short Message Service (SMS), Global System for Mobile Communications (GSM) based systems, Code Division Multiple Access (CDMA) based systems, Transmission Control Protocol/Internet Protocols (TCP/IP), or other protocols and/or systems suitable for transmitting and receiving data. Data may be transmitted and/or received wirelessly or may utilize cabled network connections or telecom connections such as an Ethernet RJ45/Category 5 Ethernet connection, a fiber connection, a traditional phone wireline connection, a cable connection or other wired network connection.

In embodiments, the subscription component 720, and the dependency component 730 may extract, transform and/or load a payload received from an issuer over a secured channel. Known techniques of extracting, transforming and/or loading may be used in concert with the other components of the system.

In embodiments, the system may also comprise a notification component that interfaces with the network component 710, a subscription component 720, a dependency component 730, a data store 740, a graphical user interface (GUI) 750 and a central processing unit (CPU) 760 to display and/or alert the holder of device. For example, the notification component may display a dialog box in the GUI as well as initiate a vibration and/or audio alert on the device.

A physical data storage device is the underlying technology behind a data store 740. The data store may comprise formats such as files, tables, or blocks stored on a device. The device can be local, remote, or in the cloud. Large data stores are typically distributed across multiple physical devices in different geographic locations. Software systems and services abstract the underlying operations of the data store. Different types of data storage devices provide varying degrees of security and redundancy. A solid-state drive (SSD) is a semiconductor technology that allows the writing and reading of data in flash memory chips. Flash storage technology was commercially available in pen drives before becoming an alternative to hard disk drives (HDD). Compared to an HDD, a physical SSD has no moving parts, which means it has faster performance and a longer lifespan. Hybrid storage array is a physical storage setup that consists of an SSD and an HDD. While an SSD offers a low-latency operation, it costs much more per-unit storage than an HDD. Therefore, organizations use a hybrid storage array to balance performance, capacity, and cost. RAID stands for a redundant array of independent disks. It is a technology that keeps the same data in multiple places on an SSD.

In some embodiments, the data store stores a persistent attribute of a credential. Database persistence is the process of storing data in a way that allows it to be retrieved later, even after the application that created it has closed. This ensures that data remains accessible, reliable, and intact. Data is written to non-volatile storage, which can retain information long-term. Non-volatile storage can include hard disk drives (HDDs), cloud storage, or other storage devices. Persistent data can be accessed and updated across multiple transactions.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
responsive to receiving from an issuer a credential by a digital wallet of a holder on a holder device, determining a dependency between the credential and a verifier;
provisioning a dataset based on the credential; and
deciding to send the dataset to the verifier wherein at least one attribute of the credential is sent to the verifier.

2. The computer-implemented method of claim 1, wherein the holder device displays via a graphical user interface of the holder device a selection whether to send the credential to the verifier and wherein the selection by the holder causes the provisioning of the dataset to omit an attribute of the credential.

3. The computer-implemented method of claim 1, comprising determining the dependency between the credential and the verifier wherein the verifier subscribes to the credential.

4. The computer-implemented method of claim 1, wherein the dataset comprises an attribute of the credential from the issuer that is persistent in the digital wallet of the holder device.

5. The computer-implemented method of claim 1, wherein the deciding is based on a change in the credential received from the issuer.

6. The computer-implemented method of claim 1, wherein the deciding is based on a request from the verifier wherein the holder determines whether to accept the request.

7. The computer-implemented method of claim 1, further comprising sending a notification to the verifier of a change to the credential received from the issuer.

8. A computer program product comprising one or more computer readable storage media, and program instructions collectively stored on the one or more computer readable storage media, the program instructions executable by a processor to cause the processor to perform operations comprising:
responsive to receiving from an issuer a credential by a holder device, determining a dependency between the credential and a verifier;
provisioning a dataset based on the credential; and
deciding to send the dataset to the verifier wherein at least one attribute of the credential is sent to the verifier.

9. The computer program product of claim 8, wherein the holder device displays via a graphical user interface of the holder device a selection whether to send the credential to the verifier and wherein the selection causes the provisioning of the dataset to omit an attribute of the credential.

10. The computer program product of claim 8, comprising determining the dependency between the credential and the verifier wherein the verifier subscribes to the credential.

11. The computer program product of claim 8, wherein the dataset comprises an attribute of the credential from the issuer that is persistent in a data store of the holder device.

12. The computer program product of claim 8, wherein the deciding is based on a change in the credential received from the issuer.

13. The computer program product of claim 8, wherein the deciding is based on a request from the verifier.

14. The computer program product of claim 8, further comprising sending a notification to the verifier of a change to the credential received from the issuer.

15. A computer system comprising a processor and one or more computer readable storage media, and program instructions collectively stored on the one or more computer readable storage media, the program instructions executable by the processor to cause the processor to perform operations comprising:
responsive to receiving from an issuer a credential by a holder device, determining a dependency between the credential and a verifier;
provisioning a dataset based on the credential; and
deciding to send the dataset to the verifier wherein at least one attribute of the credential is sent to the verifier.

16. The computer system of claim 15, wherein the holder device displays via a graphical user interface of the holder device a selection whether to send the credential to the verifier and wherein the selection causes the provisioning of the dataset to omit an attribute of the credential.

17. The computer system of claim 15, comprising determining the dependency between the credential and the verifier wherein the verifier subscribes to the credential.

18. The computer system of claim 15, wherein the dataset comprises an attribute of the credential from the issuer that is persistent in a data store of the holder device.

19. The computer system of claim 15, wherein the deciding is based on a change in the credential received from the issuer.

20. The computer system of claim 15, wherein the deciding is based on a request from the verifier.

21. The computer system of claim 15, further comprising sending a notification to the verifier of a change to the credential received from the issuer.

22. A computer-implemented method comprising:
responsive to receiving from a first issuer a first credential by a holder device, determining a first dependency between the first credential and a verifier;
determining a second dependency between a second credential and the verifier wherein the second credential is received from a second issuer based on the first credential;
provisioning a dataset based on the first credential and the second credential; and
deciding to send the dataset to the verifier wherein at least one attribute of the first credential and at least one attribute of the second credential are sent to the verifier.

23. The computer-implemented method of claim 22, wherein the dataset comprises at least one attribute of the first credential that is persistent in a data store of the holder device.

24. A system comprising:
a data store storing a credential received from an issuer;
a subscription component wherein a verifier subscribes to the credential;
a dependency component wherein the dependency component determines a dependency between at least one attribute of the credential; and
a graphical user interface wherein the graphical user interface displays the dependency.

25. The system of claim 24, further comprising a notification component wherein the notification component displays a notification responsive to receiving the credential from an issuer.
